(19) United States
(12) Patent Application Publication
(10) Pub. No.: US 2025/0391298 A1
(43) Pub. Date: Dec. 25, 2025

(54) POWER CIRCUIT AND DISPLAY DEVICE INCLUDING THE SAME

(71) Applicant: Samsung Display Co., Ltd., Yongin-si (KR)

(72) Inventors: Eunyoul BACK, Yongin-si (KR); Sung Chun PARK, Yongin-si (KR)

(21) Appl. No.: 19/244,421

(22) Filed: Jun. 20, 2025

(30) Foreign Application Priority Data
Jun. 19, 2024 (KR) 10-2024-0079594
Aug. 5, 2024 (KR) 10-2024-0103907

(51) Int. Cl. G09G 3/00; G09G 3/3233

(52) U.S. Cl. CPC G09G 3/006; G09G 3/3233; G09G 2300/0842; G09G 2330/021; G09G 2330/08

(57) ABSTRACT

A power circuit includes a first power supply including a first power output terminal configured to provide a first power supply voltage, a first abnormal output terminal configured to provide a first abnormal signal based on an abnormality occurring, and a first reset input terminal; and a second power supply including a second power output terminal which outputs a second power supply voltage, a second abnormal output terminal configured to provide a second abnormal signal based an abnormality occurring, and a second reset input terminal, wherein the first power supply is configured to stop providing the first power supply voltage and provide the first abnormal signal based on the first reset input terminal receiving the second abnormal signal, and the second power supply is configured to stop providing second power supply voltage and provide the second abnormal signal based on the second reset input terminal receiving the first abnormal signal.

### CROSS-REFERENCE TO RELATED PATENT APPLICATION

The present application claims priority to and the benefit of Korean Patent Application Number 10-2024-0079594, filed on Jun. 19, 2024, and Korean Patent Application Number 10-2024-0103907, filed on Aug. 5, 2024, in the Korean Intellectual Property Office, the entire disclosures of which are incorporated herein by reference.

### BACKGROUND

### 1. Field

Aspect of embodiments of the present disclosure relate to a power circuit and a display device including the same.

### 2. Description of the Related Art

With the development of information technology, the importance of display devices, which are the connecting medium between users and information, is being highlighted. In response, the use of display devices such as liquid crystal display devices and organic light emitting display devices is increasing.

A display device may include a plurality of power supplies and display images using power supply voltages supplied from the power supplies. The plurality of power supplies may be configured as a single integrated circuit, or may consist of a plurality of integrated circuits. If the plurality of power supplies consist of the plurality of integrated circuits, when an abnormality occurs in one integrated circuit, the problem may be how to control operations of the other integrated circuits.

The above information disclosed in this Background section is only for enhancement of understanding of the background of the invention and therefore it may contain information that does not form the prior art.

### SUMMARY

A technical object to be achieved is to provide a power circuit in which, even if an abnormality occurs in any one of a plurality of power supplies consisting of different integrated circuits, all of the plurality of power supplies can operate safely and a display device including the same. According to some embodiments of the present disclosure, there is provided a power circuit including: a first power supply including a first power output terminal configured to provide a first power supply voltage, a first abnormal output terminal configured to provide a first abnormal signal based on the occurrence of an abnormality, and a first reset input terminal; and a second power supply including a second power output terminal which outputs a second power supply voltage, a second abnormal output terminal configured to provide a second abnormal signal based on the occurrence of an abnormality, and a second reset input terminal, wherein the first power supply is configured to stop providing the first power supply voltage and provide the first abnormal signal based on the first reset input terminal receiving the second abnormal signal, and wherein the second power supply is configured to stop providing the second power supply voltage and provide the second abnormal signal based on the second reset input terminal receiving the first abnormal signal.

In some embodiments, the first power supply may further include a first enable input terminal configured to receive a first enable signal, the second power supply may further include a second enable input terminal configured to receive a second enable signal, the first power supply may be further configured to stop providing the first abnormal signal based on the reception of the first enable signal being stopped, and the second power supply may be further configured to stop providing the second abnormal signal based on the reception of the second enable signal being stopped.

In some embodiments, the first power supply may further include: a first transistor including a first electrode connected to the first abnormal output terminal and a second electrode configured to receive a first voltage; and a first abnormality detector configured to turn on the first transistor based on the occurrence of an abnormality in the first power supply, and the first abnormality detector may be configured to operate while receiving the first enable signal.

In some embodiments, the second power supply may further include: a second transistor including a first electrode connected to the second abnormal output terminal and a second electrode configured to receive the first voltage; and a second abnormality detector configured to turn on the second transistor based on the occurrence of an abnormality in the second power supply, and the second abnormality detector may be configured to operate while receiving the second enable signal.

In some embodiments, the first abnormal output terminal and the second reset input terminal maybe connected to a first electrode of a first pull-up resistor, and a second electrode of the first pull-up resistor may be configured to receive a second voltage.

In some embodiments, the second abnormal output terminal and the first reset input terminal may be connected to a first electrode of a second pull-up resistor, and a second electrode of the second pull-up resistor may be configured to receive the second voltage.

In some embodiments, the first power supply may further include: a first power supply voltage generator configured to generate the first power supply voltage; and a first on-off controller configured to control the first abnormality detector to turn on the first transistor and to stop operation of the first power supply voltage generator based on receiving the second abnormal signal, and the first power supply voltage generator and the first on-off controller may be configured to operate while receiving the first enable signal.

In some embodiments, the second power supply may further include: a second power supply voltage generator configured to generate the second power supply voltage; and a second on-off controller which may be configured to control the second abnormality detector to turn on the second transistor and to stop operation of the second power supply voltage generator based on receiving the first abnormal signal, and the second power supply voltage generator and the second on-off controller may be configured to operate while receiving the second enable signal.

In some embodiments, the first power supply may further include a first buffer between the first reset input terminal and the first on-off controller.

In some embodiments, the second power supply may further include a second buffer between the second reset input terminal and the second on-off controller.

According to some embodiments of the present disclosure, there is provided a display device including: a first power supply including a first power output terminal configured to provide a first power supply voltage, a first abnormal output terminal configured to provide a first abnormal signal based on the occurrence of an abnormality, and a first reset input terminal; a second power supply including a second power output terminal configured to provide a second power supply voltage, a second abnormal output terminal configured to provide a second abnormal signal when an abnormality occurs, and a second reset input terminal; and a display panel connected to the first power output terminal and the second power output terminal, wherein the first power supply is configured to stop providing the first power supply voltage and provide the first abnormal signal based on the first reset input terminal receiving the second abnormal signal, and wherein the second power supply is configured to stop providing the second power supply voltage and provides the second abnormal signal based on the second reset input terminal receiving the first abnormal signal.

In some embodiments, the first power supply may further include a first enable input terminal configured to receive a first enable signal, wherein the second power supply may further include a second enable input terminal configured to receive a second enable signal, wherein the first power supply may be configured to stop providing the first abnormal signal based on the reception of the first enable signal being stopped, and wherein the second power supply may be configured to stop providing the second abnormal signal based on the reception of the second enable signal being stopped.

In some embodiments, the first power supply may further include: a first transistor including a first electrode connected to the first abnormal output terminal and a second electrode configured to receive a first voltage; and a first abnormality detector configured to turn on the first transistor based on the occurrence of an abnormality in the first power supply, and the first abnormality detector may be configured to operate while receiving the first enable signal.

In some embodiments, the second power supply may further include: a second transistor including a first electrode connected to the second abnormal output terminal and a second electrode configured to receive the first voltage; and a second abnormality detector configured to turn on the second transistor based on the occurrence of an abnormality in the second power supply, and the second abnormality detector may be configured to operate while receiving the second enable signal.

In some embodiments, the first abnormal output terminal and the second reset input terminal may be connected to a first electrode of a first pull-up resistor, and a second electrode of the first pull-up resistor may be configured to receive a second voltage.

In some embodiments, the second abnormal output terminal and the first reset input terminal may be connected to a first electrode of a second pull-up resistor, and a second electrode of the second pull-up resistor may be configured to receive the second voltage.

In some embodiments, the first power supply may further include: a first power supply voltage generator configured to generate the first power supply voltage; and a first on-off controller configured to control the first abnormality detector to turn on the first transistor and to stop operation of the first power supply voltage generator based on receiving the second abnormal signal, and the first power supply voltage generator and the first on-off controller may be configured to operate while receiving the first enable signal.

In some embodiments, the second power supply may further include: a second power supply voltage generator configured to generate the second power supply voltage; and a second on-off controller which may be configured to control the second abnormality detector to turn on the second transistor and to stop operation of the second power supply voltage generator based on receiving the first abnormal signal, and wherein the second power supply voltage generator and the second on-off controller may be configured to operate while receiving the second enable signal.

In some embodiments, the first power supply may further include a first buffer between the first reset input terminal and the first on-off controller.

In some embodiments, the second power supply may further include a second buffer between the second reset input terminal and the second on-off controller.

According to some embodiments of the disclosure, there is provided an electronic device including: a display device configured to display an image; and a power circuit configured to provide power to the display device, and including: a first power supply including a first power output terminal configured to provide a first power supply voltage, a first abnormal output terminal configured to provide a first abnormal signal based on the occurrence of an abnormality, and a first reset input terminal; and a second power supply including a second power output terminal which outputs a second power supply voltage, a second abnormal output terminal configured to provide a second abnormal signal based on the occurrence of an abnormality, and a second reset input terminal, wherein the first power supply is configured to stop providing the first power supply voltage and provide the first abnormal signal based on the first reset input terminal receiving the second abnormal signal, and wherein the second power supply is configured to stop providing the second power supply voltage and provide the second abnormal signal based on the second reset input terminal receiving the first abnormal signal.

The second power supply may further include a second buffer between the second reset input terminal and the second on-off controller.

In a power circuit according to the present disclosure and a display device including the same, even if an abnormality occurs in any one of a plurality of power supplies consisting of different integrated circuits, all of the plurality of power supplies may operate safely.

### BRIEF DESCRIPTION OF THE DRAWINGS

FIG. 1 is a drawing for illustrating a display device according to some embodiments of the present disclosure.

FIG. 2 is a drawing for illustrating a pixel according to some embodiments of the present disclosure.

FIG. 3 is a drawing for illustrating a case where a first power supply and a second power supply concurrently stop supplying power according to some embodiments of the present disclosure.

FIG. 4 is a drawing for illustrating a case where the first power supply stops supplying power, but the second power supply does not stop supplying power according to some embodiments of the present disclosure.

FIG. 5 is a drawing for illustrating a power circuit according to some embodiments of the present disclosure.

FIGS. 6 to 9 are diagrams for illustrating results of testing the power circuit of FIG. 5 under various scenario situations according to some embodiments of the present disclosure.

FIG. 10 is a block diagram of an electronic device according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

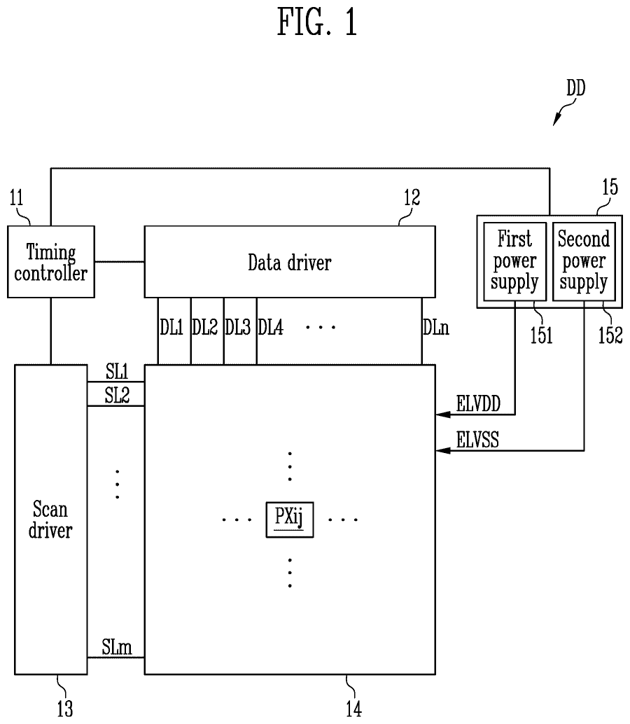

FIG. 1 is a drawing for illustrating a display device according to some embodiments of the present disclosure.

Referring to FIG. 1, a display device DD according to some embodiments of the present disclosure may include a timing controller 11, a data driver 12, a scan driver 13, and a power circuit 15.

The timing controller 11 may receive gradations and control signals for each frame from a processor. The processor may be a graphics processing unit (GPU), a central processing unit (CPU), an application processor (AP), or the like. The control signals may include a vertical synchronization signal, a horizontal synchronization signal, a data enable signal, and/or the like.

The vertical synchronization signal may include a plurality of pulses, and may indicate that the previous frame period ends and the current frame period begins based on the occurrence of each pulse. An interval between adjacent pulses of the vertical synchronization signal may correspond to a one frame period. The horizontal synchronization signal may include a plurality of pulses, and may indicate that the previous horizontal period ends and a new horizontal period begins based on the occurrence of each pulse. An interval between adjacent pulses of the horizontal synchronization signal may correspond to one horizontal period. A data enable signal may have an enable level for particular horizontal periods and a disable level for the remaining periods. When the data enable signal is at the enable level, it may indicate that color gradations are supplied in the corresponding horizontal periods.

The timing controller 11 may provide gradations and data control signals rendered or corrected to match the specifications of the display device DD to the data driver 12. In addition, the timing controller 11 may provide a clock signal, a scanning start signal, and the like, to the scan driver 13. The timing controller 11 may provide a control signal to the power circuit 15.

The data driver 12 may generate data voltages to be provided to data lines (DL1, DL2, DL3, DL4, . . . , DLn) using the gradations and data control signals received from the timing controller 11. Here, n may be an integer greater than zero (0).

The scan driver 13 may use the clock signal, the scanning start signal, and the like, received from the timing controller 11 to generate scanning signals to be provided to scanning lines (SL1, SL2, . . . , SLm). Here, m may be an integer greater than zero (0).

The scan driver 13 may sequentially supply the scanning signals with pulses of a turn-on level to the scanning lines (SL1, SL2, . . . , SLm). For example, the scan driver 13 may supply the scanning signals of the turn-on level to the scanning lines at a period corresponding to a cycle of the horizontal synchronization signal. The scan driver 13 may include scanning stages configured in the form of a shift register. The scan driver 13 may generate the scanning signals by sequentially transmitting the scanning start signal in the form of a pulse of a turn-on level to the next scanning stage under control of the clock signal.

A display panel 14 may include pixels. Each pixel may be connected to a corresponding data line and scanning line. For example, a pixel (PXij) may be connected to an i-th scanning line and a j-th data line. The pixels may include pixels emitting light of a first color, pixels emitting light of a second color, and pixels emitting light of a third color. The first, second, and third colors may be different colors. For example, the first color may be one of red, green, and blue, the second color may be a color other than the first color among red, green, and blue, and the third color may be a color other than the first color and the second color among red, green, and blue. For example, magenta, cyan, and yellow may be used instead of red, green, and blue as the first to third colors. In some embodiments, for convenience of explanation, the first color, the second color, and the third color are described as red, green, and blue.

The power circuit 15 may include a first power supply 151 and a second power supply 152. The first power supply 151 may provide a first power supply voltage ELVDD (see, e.g., FIG. 3) through a first power output terminal. The second power supply 152 may provide a second power supply voltage ELVSS (see, e.g., FIG. 3) through a second power output terminal. When displaying an image, the first power supply voltage ELVDD may be set higher than the second power supply voltage ELVSS. Each of the first power supply 151 and the second power supply 152 may include at least one voltage converter. For example, the first power supply 151 may include a boost converter and the second power supply 152 may include an inverting buck-boost converter.

The display panel 14 may be connected to the first power output terminal and the second power output terminal. For example, the display panel 14 may receive the first power supply voltage ELVDD from the first power output terminal of the first power supply 151 and the second power supply voltage ELVSS from the second power output terminal of the second power supply 152. The pixels of the display panel 14 may display an image by using driving currents flowing between the first power supply voltage ELVDD and the second power supply voltage ELVSS.

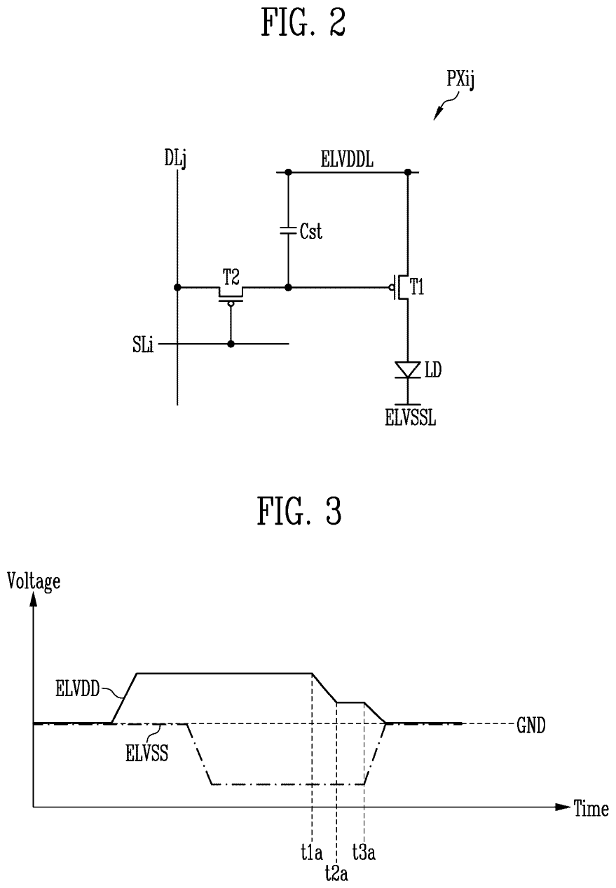

FIG. 2 is a drawing for illustrating a pixel according to some embodiments of the present disclosure.

Referring to FIG. 2, a pixel (PXij) is shown. Other pixels may also have substantially the same configuration, so redundant descriptions are omitted.

A transistor T1 may include a gate electrode connected to a second electrode of a storage capacitor Cst, a first electrode connected to a first power line ELVDDL, and a second electrode connected to an anode of a light-emitting diode LD. The transistor T1 may be named a driving transistor. The first power supply voltage ELVDD may be applied to the first power line ELVDDL.

The transistor T2 may include a gate electrode connected to the i-th scanning line SLi, a first electrode connected to the j-th data line DLj, and a second electrode connected to a second electrode of the storage capacitor Cst. The transistor T2 may be named a scan transistor.

The first electrode of the storage capacitor Cst may be connected to the first power line ELVDDL, and the second electrode of the storage capacitor Cst may be connected to the gate electrode of the transistor T1.

The light-emitting diode LD may include an anode connected to the second electrode of the transistor T1 and a cathode connected to a second power line ELVSSL. The second power supply voltage ELVSS may be applied to the second power line ELVSSL. During a light-emitting period of the light-emitting diode LD, the first power supply voltage ELVDD may be greater than the second power supply voltage ELVSS.

Here, the transistors (T1 and T2) are shown as P-type transistors, but the present disclosure is not limited thereto and a person skilled in the art would also be able to reverse the polarity of signals and replace at least one of the transistors with an N-type transistor.

When the scanning signal of the turn-on level is applied to the i-th scanning line SLi, the transistor T2 may be turned on. At this time, a data voltage charged in the j-th data line DLj may be stored in the storage capacitor Cst. The transistor T1 may flow driving current in response to a gate-source voltage difference maintained by the storage capacitor Cst. The driving current may flow in a path of the first power line ELVDDL, the transistor T1, the light-emitting diode LD, and the second power line ELVSSL. The light-emitting diode LD may emit light with a brightness which corresponds to the amount of driving current.

FIG. 3 is a drawing for illustrating a case where the first power supply and the second power supply concurrently (e.g., simultaneously) stop supplying power according to some embodiments of the present disclosure.

As shown in FIG. 3, in some embodiments, the first power supply 151 and the second power supply 152 of the power circuit 15 may be configured as a single integrated circuit. For example, when the display device DD is powered on, a voltage level of the first power supply voltage ELVDD may increase, and a voltage level of the second power supply voltage ELVSS may decrease, thereby allowing the driving current to flow between the first power supply voltage ELVDD and the second power supply voltage ELVSS. For example, when the display device DD is powered on, the display device DD may display the image.

As shown in FIG. 3, a short circuit occurs in a part of the first power line ELVDDL of the display panel 14 at a time point t1a. Due to the short circuit, the voltage level of the first power supply voltage ELVDD may gradually decrease until a time point t2a. An abnormality detector of the power circuit 15 may detect an abnormality of the first power supply voltage ELVDD. At this time, the power circuit 15 may stop power supply of the first power supply 151 and the second power supply 152 from a time point t3a. Thus, from the time point t3a, the voltage level of the first power supply voltage ELVDD and the voltage level of the second power supply voltage ELVSS may converge to a ground level GND.

In other words, if the first power supply 151 and the second power supply 152 are configured as a single integrated circuit, when an abnormality is detected in either the first power supply 151 or the second power supply 152, no special problem occurs (e.g., a serious problem may be avoided) because protective operations may be performed concurrently (e.g., simultaneously).

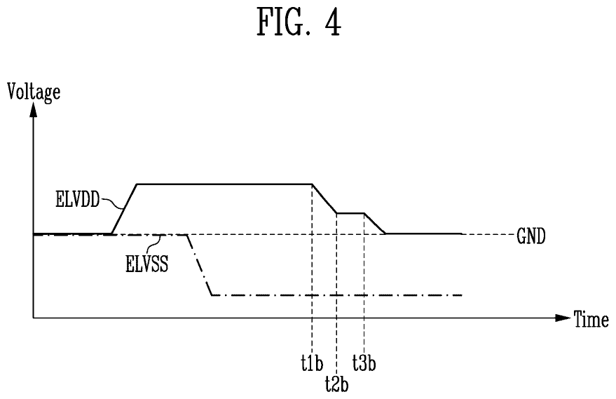

FIG. 4 is a drawing for illustrating a case where the first power supply stops supplying power, but the second power supply does not stop supplying power according to some embodiments of the present disclosure.

In FIG. 4, it is shown that the first power supply 151 and the second power supply 152 of the power circuit 15 may be implemented by different integrated circuits. For example, when the display device DD is powered on, the voltage level of the first power supply voltage ELVDD may increase and the voltage level of the second power supply voltage ELVSS may decrease, thereby allowing the driving current to flow between the first power supply voltage ELVDD and the second power supply voltage ELVSS. For example, when the display device DD is powered on, the display device DD may display the image.

As shown in FIG. 4, a short circuit occurs in a part of the first power line ELVDDL of the display panel 14 at a time point t1b. Due to the short circuit, the voltage level of the first power supply voltage ELVDD may gradually decrease until a time point t2b. The abnormality detector of the first power supply 151 may detect an abnormality of the first power supply voltage ELVDD. At this time, the first power supply 151 may stop supplying power from a time point t3b. Thus, from the time point t3b, the voltage level of the first power supply voltage ELVDD may converge to the ground level GND.

However, because the abnormality detector of the second power supply 152 was unable to detect an abnormality of the second power supply voltage ELVSS, the second power supply 152 may still continue to supply power even after the time point t3b. In such cases, there is a risk that the display panel 14 may display an incorrect image or that burning may occur due to current surge.

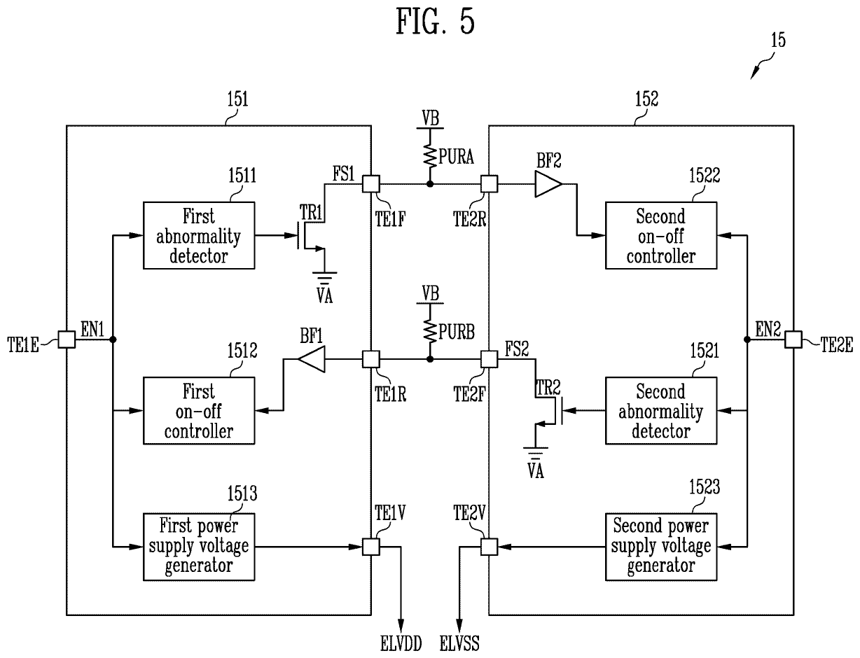

FIG. 5 is a drawing for illustrating a power circuit according to some embodiments of the present disclosure.

The first power supply 151 may include a first power output terminal TE1V which provides the first power supply voltage ELVDD. In addition, the first power supply 151 may further include a first abnormal output terminal TE1F which provides a first abnormal signal FS1 when an abnormality occurs, a first reset input terminal TE1R which receives a second abnormal signal FS2, and a first enable input terminal TE1E which receives a first enable signal EN1.

The second power supply 152 may include a second power output terminal TE2V which provides the second power supply voltage ELVSS. In addition, the second power supply 152 may further include a second abnormal output terminal TE2F which provides the second abnormal signal FS2 when an abnormality occurs, a second reset input terminal TE2R which receives the first abnormal signal FS1, and a second enable input terminal TE2E which receives a second enable signal EN2.

When the first reset input terminal TE1R receives the second abnormal signal FS2, the first power supply 151 may stop providing the first power supply voltage ELVDD and provide the first abnormal signal FS1. Similarly, when the second reset input terminal TE2R receives the first abnormal signal FS1, the second power supply 152 may stop providing the second power supply voltage ELVSS and provide the second abnormal signal FS2.

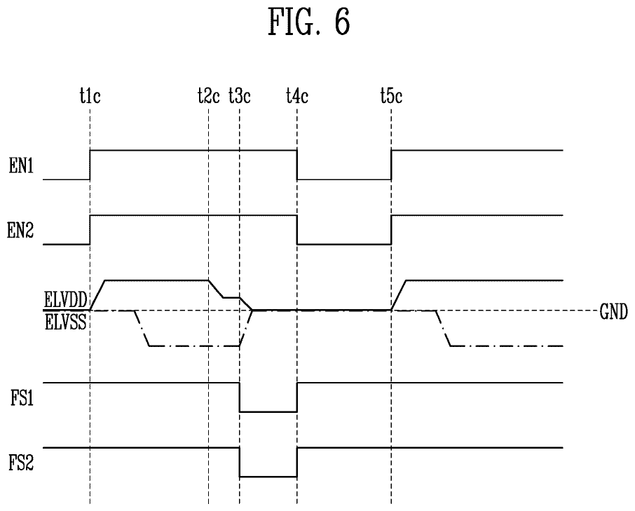

According to some embodiments, the first power supply 151 and the second power supply 152 may operate safely even in situations where the first enable signal EN1 and the second enable signal EN2, which are external input signals (e.g., output signals of the timing controller 11), are set in various ways. This will be described later with reference to FIGS. 6 to 9.

Referring to FIG. 5, the first power supply 151 according to some embodiments of the present disclosure may include a first abnormality detector 1511, a first on-off controller 1512, and a first power supply voltage generator 1513. According to embodiments, the first power supply 151 may further include a first transistor TR1 and a first buffer BF1.

The first transistor TR1 may include a first electrode connected to the first abnormal output terminal TE1F and a second electrode which receives a first voltage VA. For example, the first voltage VA may have a ground voltage level. For example, the first transistor TR1 may be an N-type transistor. The first transistor TR1 may be connected to the first abnormal output terminal TE1F in an open-drain manner.

The first abnormal output terminal TE1F and the second reset input terminal TE2R may be connected to a first electrode of a first pull-up resistor PURA. A second electrode of the first pull-up resistor PURA may receive a second voltage VB. The second voltage VB may be set higher than the first voltage VA.

The first transistor TR1 may be normally in a turn-off state. Therefore, when the first power supply 151 operates normally, a voltage level of the first abnormal output terminal TE1F may be maintained at a high level based on the second voltage VB. When the voltage level of the first abnormal output terminal TE1F is at the high level, it may be determined that the first abnormal signal FS1 is not provided from the first abnormal output terminal TE1F.

The first abnormality detector 1511 may operate while receiving the first enable signal EN1. Accordingly, the first power supply 151 may stop providing the first abnormal signal FS1 if the reception of the first enable signal EN1 is stopped. When the first enable signal EN1 is at the high level, the first enable signal EN1 may be received. However, the definition of the first enable signal EN1 may vary depending on the communication protocol between the integrated circuits.

The first abnormality detector 1511 may turn on the first transistor TR1 when an abnormality in the first power supply 151 is detected (for example, when the voltage level of the first power supply voltage ELVDD is abnormal). For example, the voltage level of the first abnormal output terminal TE1F may be changed to a low level based on the first voltage VA. When the voltage level of the first abnormal output terminal TE1F is the low level, the first abnormal signal FS1 may be provided from the first abnormal output terminal TE1F.

The first power supply voltage generator 1513 may generate the first power supply voltage ELVDD. For example, the first power supply voltage generator 1513 may be configured as a boost converter. The first power supply voltage generator 1513 may operate while receiving the first enable signal EN1.

When receiving the second abnormal signal FS2, the first on-off controller 1512 may control the first abnormality detector 1511 to turn on the first transistor TR1. In addition, when receiving the second abnormal signal FS2, the first on-off controller 1512 may stop the operation of the first power supply voltage generator 1513. The first on-off controller 1512 may operate while receiving the first enable signal EN1. According to embodiments, the first buffer BF1 may be located between the first reset input terminal TE1R and the first on-off controller 1512. The first buffer BF1 may prevent a voltage level of the first reset input terminal TE1R from fluctuating, or significantly reduce the amount of fluctuation, due to the operation of the first on-off controller 1512.

The second power supply 152 according to some embodiments of the present disclosure may include a second abnormality detector 1521, a second on-off controller 1522, and a second power supply voltage generator 1523. According to embodiments, the second power supply 152 may further include a second transistor TR2 and a second buffer BF2.

The second transistor TR2 may include a first electrode connected to the second abnormal output terminal TE2F and a second electrode which receives the first voltage VA. For example, the second transistor TR2 may be an N-type transistor. The second transistor TR2 may be connected to the second abnormal output terminal TE2F in an open-drain manner.

The second abnormal output terminal TE2F and the first reset input terminal TE1R may be connected to a first electrode of a second pull-up resistor PURB. A second electrode of the second pull-up resistor PURB may receive the second voltage VB.

The second transistor TR2 may be normally in a turn-off state. Accordingly, when the second power supply 152 operates normally, a voltage level of the second abnormal output terminal TE2F may be maintained at a high level based on the second voltage VB. When the voltage level of the second abnormal output terminal TE2F is at the high level, the second abnormal signal FS2 may not be provided from the second abnormal output terminal TE2F.

The second abnormality detector 1521 may operate while receiving the second enable signal EN2. Accordingly, the second power supply 152 may stop providing the second abnormal signal FS2 if the reception of the second enable signal EN2 is stopped. When the second enable signal EN2 is at a high level, the second enable signal EN2 may be received. However, the definition of the second enable signal EN2 may vary depending on the communication protocol between the integrated circuits.

The second abnormality detector 1521 may turn on the second transistor TR2 when an abnormality in the second power supply 152 is detected (e.g., when the voltage level of the second power supply voltage ELVSS is abnormal). At this time, the voltage level of the second abnormal output terminal TE2F may be changed to a low level based on the first voltage VA. When the voltage level of the second abnormal output terminal TE2F is at the low level, the second abnormal signal FS2 may be provided from the second abnormal output terminal TE2F.

The second power supply voltage generator 1523 may generate the second power supply voltage ELVSS. For example, the second power supply voltage generator 1523 may be configured as an inverting buck-boost converter. The second power supply voltage generator 1523 may operate while receiving the second enable signal EN2.

When receiving the first abnormal signal FS1, the second on-off controller 1522 may control the second abnormality detector 1521 to turn on the second transistor TR2. In addition, when receiving the first abnormal signal FS1, the second on-off controller 1522 may stop the operation of the second power supply voltage generator 1523. The second on-off controller 1522 may operate while receiving the second enable signal EN2. According to embodiments, the second buffer BF2 may be located between the second reset input terminal TE2R and the second on-off controller 1522. The second buffer BF2 may prevent a voltage level of the second reset input terminal TE2R from fluctuating due to the operation of the second on-off controller 1522.

FIGS. 6 to 9 are diagrams for illustrating results of testing the power circuit of FIG. 5 under various scenario situations according to some embodiments of the present disclosure.

Referring to FIG. 6, at a time point (e.g., a time or point in time) t1c, the first power supply 151 may receive the first enable signal EN1, and the second power supply 152 may receive the second enable signal EN2. At a time point t2c, an abnormality (e.g., a short circuit) occurs in a part of the display panel 14 connected to the first power supply 151.

At a time point t3c, the first abnormality detector 1511 may turn on the first transistor TR1, and the voltage level of the first abnormal output terminal TE1F may be changed to the low level. Thus, the first abnormal signal FS1 may be provided from the first abnormal output terminal TE1F. At this time, because the second on-off controller 1522 receives the first abnormal signal FS1, it may control (e.g., cause) the second abnormality detector 1521 to turn on the second transistor TR2. Thus, the second abnormal signal FS2 may be provided from the second abnormal output terminal TE2F. In addition, the second on-off controller 1522 may receive the first abnormal signal FS1 and thus may stop the operation of the second power supply voltage generator 1523. The first on-off controller 1512 may receive the second abnormal signal FS2, and thus, may stop the operation of the first power supply voltage generator 1513. Therefore, the provision of the second power supply voltage ELVSS from the second power supply 152 may be stopped, and the provision of the first power supply voltage ELVDD from the first power supply 151 may be stopped.

At a time point t4c, the provision of the first enable signal EN1 and the provision of the second enable signal EN2 may be stopped. Therefore, the operation of the first abnormality detector 1511 and the operation of the second abnormality detector 1521 may be stopped, and the provision of the first abnormal signal FS1 and the provision of the second abnormal signal FS2 may be stopped.

At a time point t5c, the first power supply 151 may receive the first enable signal EN1, and the second power supply 152 may receive the second enable signal EN2. Accordingly, the first power supply voltage generator 1513 may provide the first power supply voltage ELVDD and the second power supply voltage generator 1523 may provide the second power supply voltage ELVSS. Thereafter, in the case that current flows to a portion of the display panel 14 where an abnormality occurs (e.g., a specific pixel where a short circuit occurs), the operations of the first power supply 151 and the second power supply 152 may be performed again in a similar manner as at the time points t2c and t3c.

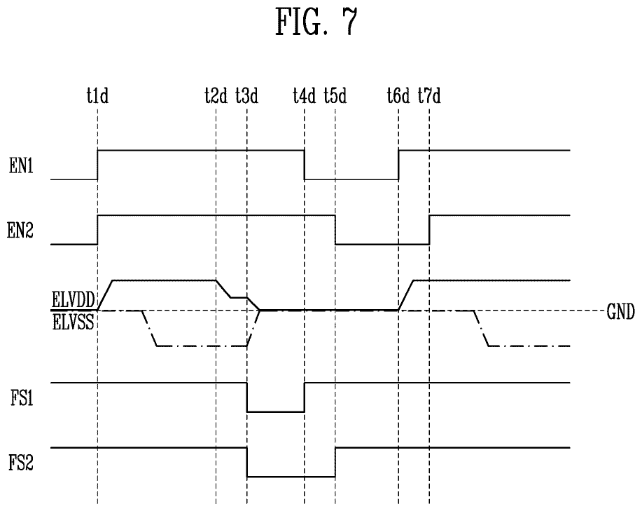

Referring to FIG. 7, operations of the first power supply 151 and the second power supply 152 at time points t1d, 2d, and t3d may be the same as the operations of the first power supply 151 and the second power supply 152 at the time points t1c, t2c, and t3c of FIG. 6. Therefore, duplicate explanation thereof is omitted.

At a time point t4d, provision of the first enable signal EN1 may be stopped, and the first abnormality detector 1511 may stop provision of the first abnormal signal FS1. In addition, at a time point t5d, provision of the second enable signal EN2 may be stopped, and the second abnormality detector 1521 may stop provision of the second abnormal signal FS2.

At a time point t6d, the first power supply 151 may receive the first enable signal EN1, and at a time point t7d, the second power supply 152 may receive the second enable signal EN2. Accordingly, the first power supply voltage generator 1513 may provide the first power supply voltage ELVDD and the second power supply voltage generator 1523 may provide the second power supply voltage ELVSS. Thereafter, in the case that current flows to a portion of the display panel 14 where an abnormality occurs (e.g., a specific pixel where a short circuit occurs), the operations of the first power supply 151 and the second power supply 152 at the time points t2d, t3d may be performed again.

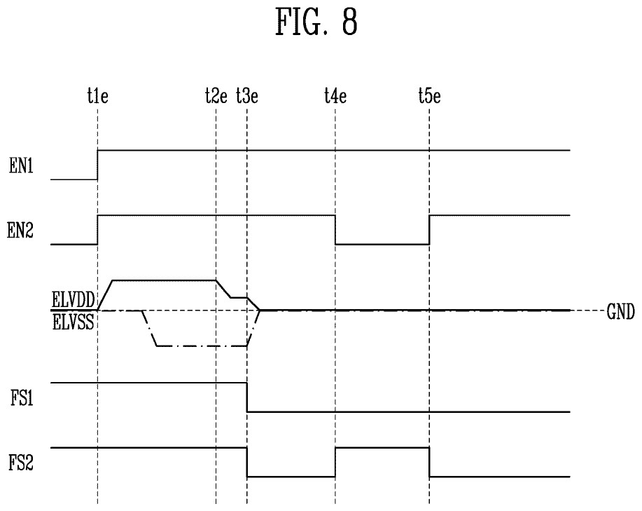

Referring to FIG. 8, operations of the first power supply 151 and the second power supply 152 at time points t1e, t2e, and t3e may be the same as the operations of the first power supply 151 and the second power supply 152 at the time points t1c, t2c, and t3c of FIG. 6. Therefore, duplicate explanation thereof is omitted.

Referring to FIG. 8, a situation in which the provision of the first enable signal EN1 continues is shown. Even if the provision of the second enable signal EN2 is stopped at a time point t4e and the provision of the second enable signal EN2 is restarted at a time point t5e, because the first abnormal signal FS1 is still provided, the second on-off controller 1522 stops the operation of the second power supply voltage generator 1523.

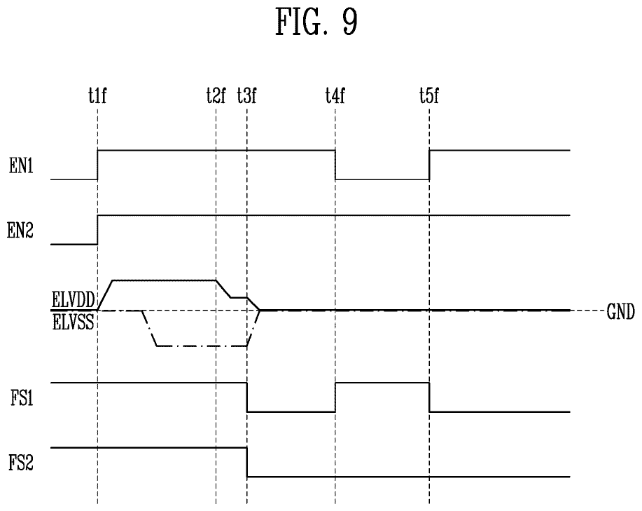

Referring to FIG. 9, operations of the first power supply 151 and the second power supply 152 at time points t1f, t2f, and t3f may be the same as the operations of the first power supply 151 and the second power supply 152 at the time points t1c, t2c, and t3c of FIG. 6. Therefore, duplicate explanation thereof is omitted.

Referring to FIG. 9, a situation in which the provision of the second enable signal EN2 continues is shown. Even if the provision of the first enable signal EN1 is stopped at a time point t4f and the provision of the first enable signal EN1 is restarted at a time point t5f, because the second abnormal signal FS2 is still provided, the first on-off controller 1512 stops the operation of the first power supply voltage generator 1513.

Referring to the timing charts of FIGS. 6 to 9, it can be seen that the first power supply 151 and the second power supply 152 can operate safely under various scenario situations.

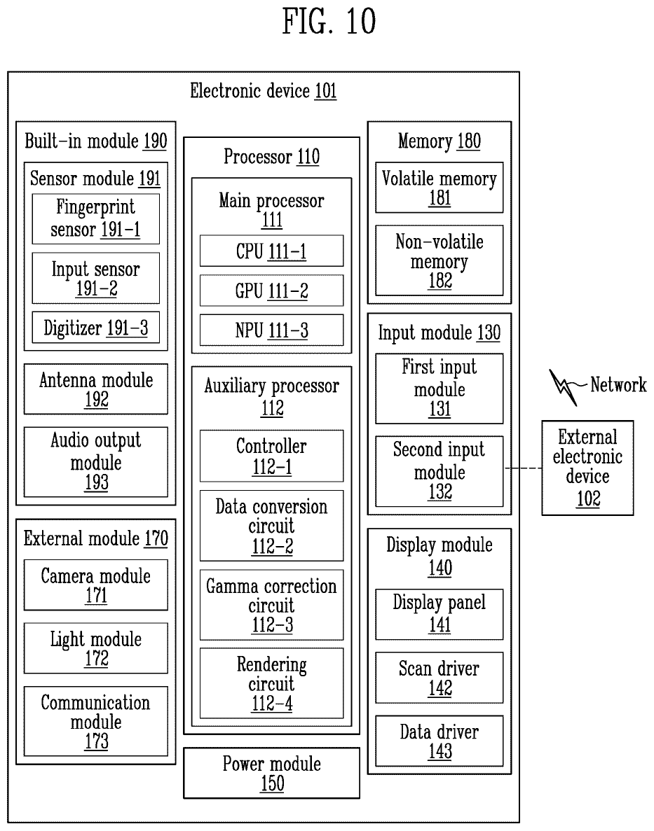

FIG. 10 is a block diagram of an electronic device according to some embodiments of the present disclosure.

An electronic device 101 outputs a variety of information through a display module 140 within an operating system. When a processor 110 runs an application stored in a memory 180, the display module 140 provides application information to a user through a display panel 141.

The processor 110 acquires an external input through an input module 130 or a sensor module 191 and executes an application corresponding to the external input. For example, if the user selects a camera icon displayed on the display panel 141, the processor 110 may acquire user input through an input sensor 191-2 and activates a camera module 171. The processor 110 may transmit image data corresponding to a photographed image acquired through the camera module 171 to the display module 140. The display module 140 may display an image corresponding to the photographed image through the display panel 141.

As another example, when personal information authentication is performed in the display module 140, a fingerprint sensor 191-1 may acquire input fingerprint information as input data. The processor 110 may compare the input data acquired through the fingerprint sensor 191-1 with authentication data stored in the memory 180 and may execute the application according to the comparison result. The display module 140 may display information executed according to a logic of the application through the display panel 141.

In another example, if a music streaming icon displayed by the display module 140 is selected, the processor 110 may acquire user input through the input sensor 191-2 and activate a music streaming application stored in the memory 180. When a music execution command is input in the music streaming application, the processor 110 may activate an audio output module 193 to provide the user with audio information corresponding to the music execution command.

As above, the operation of the electronic device 101 has been briefly described. Hereinafter, a configuration of the electronic device 101 will be described in detail. Some of components of the electronic device 101 described below may be integrated and provided as one component, and one component may be provided by being separated into two or more components.

Referring to FIG. 10, the electronic device 101 may communicate with an external electronic device 102 through a network (e.g., a short-range wireless communication network or long-range wireless communication network). According to some embodiments, the electronic device 101 may include the processor 110, the memory 180, the input module 130, the display module 140, a power module 150, a built-in module 190, and an external module 170. According to some embodiments, the electronic device 101 may have at least one of the above-described components omitted, or one or more other components added. According to some embodiments, some of the components described above (e.g., the sensor module 191, an antenna module 192, or the audio output module 193) may be integrated into another component (e.g., the display module 140).

The processor 110 may execute software to control at least one other component (e.g., hardware or software component) of the electronic device 101 connected to the processor 110 and to perform various data processing or operations. According to some embodiments, as at least part of the data processing or operations, the processor 110 may store instructions or data received from other components (e.g., the input module 130, the sensor module 191, or a communication module 173) in a volatile memory 181, process the instructions or data stored in the volatile memory 181, and store resulting data in a non-volatile memory 182.

The processor 110 may include a main processor 111 and an auxiliary processor 112. The main processor 111 may include one or more of a central processing unit (CPU) 111-1 or an application processor (AP). The main processor 111 may further include one or more of a graphic processing unit (GPU) 111-2, a communication processor (CP), and an image signal processor (ISP). The main processor 111 may further include a neural processing unit (NPU) 111-3. The neural network processing unit is a processor specialized in the processing of artificial intelligence (AI) models, which can be created through machine learning. The AI model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of them, but is not limited to the foregoing. The AI model may additionally or alternatively include a software structure in addition to a hardware structure. At least two of the above-described processing units and processors may be implemented in a single integrated configuration (e.g., a single chip), or each may be implemented in an independent configuration (e.g., multiple chips).

The auxiliary processor 112 may include a controller 112-1. The controller 112-1 may include an interface conversion circuit and a timing control circuit. The controller 112-1 may receive an image signal from the main processor 111, convert data format of the image signal to match the interface specifications with the display module 140, and output image data. The controller 112-1 may output various control signals desired for the operation of the display module 140.

The auxiliary processor 112 may further include a data conversion circuit 112-2, a gamma correction circuit 112-3, and a rendering circuit 112-4. The data conversion circuit 112-2 may receive the image data from the controller 112-1, and compensate for the image data so that the image is displayed at a desired brightness according to the characteristics of the electronic device 101 or the user's settings or convert the image data to reduce power consumption or compensate for afterimages. The gamma correction circuit 112-3 may convert the image data or a gamma reference voltage, so that the image displayed in the electronic device 101 has desired gamma characteristics. The rendering circuit 112-4 may receive the image data from the controller 112-1 and render the image data in consideration of pixel arrangement of the display panel 141 applied to the electronic device 101. At least one of the data conversion circuit 112-2, the gamma correction circuit 112-3, and the rendering circuit 112-4 may be integrated into another component (e.g., the main processor 111 or the controller 112-1). At least one of the data conversion circuit 112-2, the gamma correction circuit 112-3, and the rendering circuit 112-4 may be integrated into a data driver 143 described below.

The memory 180 may store various data used by at least one component (e.g., the processor 110 or the sensor module 191) of the electronic device 101 and input data or output data for instructions related thereto. The memory 180 may include at least one or more of the volatile memory 181 and the non-volatile memory 182.

The input module 130 may receive instructions or data to be used in the components of the electronic device 101 (e.g., the processor 110, the sensor module 191, or the audio output module 193) from the outside of the electronic device 101 (e.g., the user or the external electronic device 102).

The input module 130 may include a first input module 131 into which a command or data is input from the user and a second input module 132 into which a command or data is input from the external electronic device 102. The first input module 131 may include a microphone, a mouse, a keyboard, keys (e.g., buttons), or a pen (e.g., a passive pen or active pen). The second input module 132 may support a specified protocol which may be connected, either wired or wirelessly, to the external electronic device 102. In some embodiments, the second input module 132 may include a high-definition multimedia interface (HDMI), a universal serial bus (USB) interface, an SD card interface, an audio interface, or a combination thereof. The second input module 132 may include a connector which can be physically connected to the external electronic device 102, for example, an HDMI connector, a USB connector, an SD card connector, or an audio connector (e.g., a headphone connector).

The display module 140 provides information visually to the user. The display module 140 may include the display panel 141, a scan driver 142, and a data driver 143. The display module 140 may further include a window, chassis, and bracket to protect the display panel 141.

The display panel 141 may include a liquid crystal display panel, an organic light-emitting display panel, an inorganic light-emitting display panel, or the like, and the type of the display panel 141 is not particularly limited. The display panel 141 may be of a rigid type, or a rollable or foldable flexible type. The display module 140 may further include a supporter, bracket, heat dissipation element, or the like supporting the display panel 141.

The scan driver 142 may be mounted on the display panel 141 as a driving chip. In some embodiments, the scan driver 142 may be integrated into the display panel 141. For example, the scan driver 142 may include an amorphous silicon TFT gate driver circuit (ASG), a low temperature polycrystalline silicon (LTPS), a TFT gate driver circuit, or an oxide semiconductor TFT gate driver circuit (OSG) built into the display panel 141. The scan driver 142 may receive a control signal from the controller 112-1 and, in response to the control signal, may output scan signals to the display panel 141.

The display panel 141 may further include a light-emitting driver. The light-emitting driver may respond to the control signal received from the controller 112-1 and may output a light-emitting control signal to the display panel 141. The light-emitting driver may be formed separately from the scan driver 142, or may be integrated into the scan driver 142.

The data driver 143 may receive a control signal from the controller 112-1 and, in response to the control signal, convert the image data to analog voltages (e.g., data voltages) and outputs the data voltages to the display panel 141.

The data driver 143 may be integrated into other components (e.g., the controller 112-1). The functions of the interface conversion circuit and the timing control circuit of the controller 112-1 as described above may be integrated into the data driver 143.

The display module 140 may further include a light-emitting driver and a voltage generation circuit. The voltage generation circuit may output various voltages required to drive the display panel 141.

The power module 150 supplies power to the components of the electronic device 101. The power module 150 may include a battery to charge the power supply voltage. The battery may include a non-rechargeable primary battery, a rechargeable secondary battery, and/or a fuel cell. The power module 150 may include a power management integrated circuit (PMIC). The PMIC provides suitable power for each of the modules described above and modules described below. The power module 150 may include a wireless power transmitting and receiving member electrically connected to the battery. The wireless power transmitting and receiving member may include a plurality of antenna emitters in the form of coils. The power circuit 15 of FIG. 1 may correspond to the power module 150.

The electronic device 101 may further include the built-in module 190 and the external module 170. The built-in module 190 may include the sensor module 191, the antenna module 192, and the audio output module 193. The external module 170 may include the camera module 171, a light module 172, and the communication module 173.

The sensor module 191 may detect an input by the user's body or an input by the pen among the first input module 131 and generate an electrical signal or data value corresponding to the input. The sensor module 191 may include at least one or more of the fingerprint sensor 191-1, the input sensor 191-2, and a digitizer 191-3.

The fingerprint sensor 191-1 may generate a data value corresponding to the user's fingerprint. The fingerprint sensor 191-1 may include either an optical or capacitive fingerprint sensor.

The input sensor 191-2 may generate a data value corresponding to coordinate information of the input by the user's body or input by the pen. The input sensor 191-2 generates the amount of capacitance change by the input as a data value. The input sensor 191-2 may detect an input by the passive pen or transmit and receive data with the active pen.

The input sensor 191-2 may also measure vital signs, such as blood pressure, moisture, or body fat. For example, if the user touches a part of the body to a sensor layer or a sensing panel and does not move for a set period of time (e.g., a preset or predetermined period of time), based on changes in the electric field caused by the body part, the input sensor 191-2 may detect bio-signals and output information desired by the user to the display module 140.

The digitizer 191-3 may generate a data value corresponding to the coordinate information of the input by the pen. The digitizer 191-3 may generate the amount of electromagnetic change by the input as the data value. The digitizer 191-3 may detect input by the passive pen or transmit and receive data with the active pen.

At least one of the fingerprint sensor 191-1, the input sensor 191-2, and the digitizer 191-3 may be implemented as a sensor layer formed on the display panel 141 by means of a continuous process. The fingerprint sensor 191-1, the input sensor 191-2, and the digitizer 191-3 may be placed on the upper side of the display panel 141, and any one of the fingerprint sensor 191-1, the input sensor 191-2, and the digitizer 191-3, for example, the digitizer 191-3, may be placed on the lower side of the display panel 141.

At least two of the fingerprint sensor 191-1, the input sensor 191-2, and the digitizer 191-3 may be configured to be integrated into a single sensing panel by the same process. When integrated into the single sensing panel, the sensing panel may be placed between the display panel 141 and a window placed on the upper side of the display panel 141. According to some embodiments, the sensing panel may be placed on the window, and the position of the sensing panel is not particularly limited.

At least one of the fingerprint sensor 191-1, the input sensor 191-2, and the digitizer 191-3 may be embedded in the display panel 141. For example, at least one of the fingerprint sensor 191-1, the input sensor 191-2, and the digitizer 191-3 may be formed concurrently (e.g., simultaneously) through a process of forming elements (e.g., light-emitting elements, transistors, etc.) included in the display panel 141.

In addition, the sensor module 191 may generate electrical signals or data values corresponding to the internal or external state of the electronic device 101. The sensor module 191 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, an ambient light sensor, and/or the like.

The antenna module 192 may include one or more antennas for transmitting or receiving signals or power to the outside or from the outside. According to some embodiments, the communication module 173 may transmit a signal to an external electronic device through an antenna suitable for a communication method, or receive it from the external electronic device. An antenna pattern of the antenna module 192 may be integrated into one component of the display module 140 (e.g., the display panel 141) or the input sensor 191-2.

The audio output module 193 is a device for outputting an audio signal to the outside of the electronic device 101, and may include, for example, a speaker used for general purposes, such as multimedia playback or recording playback, and a receiver used for telephone reception. According to some embodiments, the receiver may be formed integrally with the speaker or separately. An audio output pattern of the audio output module 193 may be integrated into the display module 140.

The camera module 171 may shoot still images and videos. According to some embodiments, the camera module 171 may include one or more lenses, an image sensor, and/or an image signal processor. The camera module 171 may further include an infrared camera which is able to measure the presence or absence of a user, the user's location, the user's line of sight, and/or the like.

The light module 172 may provide light. The light module 172 may include a light-emitting diode or a xenon lamp. The light module 172 may operate in conjunction with the camera module 171 or independently.

The communication module 173 may assist in the establishment of a wired or wireless communication channel between the electronic device 101 and the external electronic device 102 and communication over an established communication channel. The communication module 173 may include one or more of: a wireless communication module, such as a cellular communication module; a short-range wireless communication module; a global navigation satellite system (GNSS) communication module; and a wired communication module, such as a local area network (LAN) communication module or a power line communication module. The communication module 173 may communicate with the external electronic device 102 via a short-range communication network, such as Bluetooth, WiFi direct, or IrDA (infrared data association), or a long-range communication network, such as a cellular network, the Internet, or a computer network (e.g., a LAN or WAN). The various types of communication modules 173 described above may be implemented as one chip or as separate chips.

The input module 130, the sensor module 191, the camera module 171, and the like may be used to control the operation of the display module 140 in conjunction with the processor 110.

The processor 110 may output commands or data to the display module 140, the audio output module 193, the camera module 171, and/or the light module 172 based on the input data received from input module 130. For example, the processor 110 may generate image data in response to input data received through the mouse or the active pen, etc., and output the data to the display module 140, or generate command data in response to the input data and output the data to the camera module 171 or the light module 172. When no input data is received from the input module (130) for a set period of time (e.g., a preset or predetermined period of time), the processor 110 may reduce power consumption in the electronic device 101 by switching the operation mode of the electronic device 101 to a low power mode or sleep mode.

The processor 110 may output commands or data to the display module 140, the audio output module 193, the camera module 171, and/or the light module 172 based on the sensing data received from the sensor module 191. For example, the processor 110 may compare authentication data authorized by the fingerprint sensor 191-1 with authentication data stored in the memory 180 and then execute an application based on the comparison result. The processor 110 may execute a command based on the sensing data detected by the input sensor 191-2 or digitizer 191-3 or output the corresponding image data to the display module 140. If the sensor module 191 includes a temperature sensor, the processor 110 may receive temperature data for the measured temperature from the sensor module 191 and, based on the temperature data, further perform luminance correction for the image data.

The processor 110 may receive measurement data from the camera module 171 about the presence or absence of the user, the user's position, the user's line of sight, etc. The processor 110 may further perform luminance correction on the image data based on the measurement data. For example, the processor 110, which determines the presence or absence of the user through input from camera module 171, may output image data whose luminance has been corrected to the display module 140 through the data conversion circuit 112-2 or the gamma correction circuit 112-3.

Some of the components may be connected to each other via a communication method between peripherals, e.g., buses, general purpose input/output (GPIO), serial peripheral interface (SPI), mobile industry processor interface (MIPI), ultra-path interconnect (UPI) links, or the like and may exchange signals (e.g., commands or data) with each other. The processor 110 may communicate with the display module 140 through a mutually agreed upon interface, and for example, use any one of the above-described communication methods, including but not limited to the above-described communication methods.

The electronic device 101 according to the various embodiments disclosed herein may be a device of various types. The electronic device 101 may include, for example, at least one of portable communication devices (e.g., smart phones), computer devices, portable multimedia devices, portable medical devices, cameras, wearable devices, or consumer electronics devices. The electronic device 101 according to the embodiments of the present specification is not limited to the aforementioned devices.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A power circuit comprising:
a first power supply comprising a first power output terminal configured to provide a first power supply voltage, a first abnormal output terminal configured to provide a first abnormal signal based on the occurrence of an abnormality, and a first reset input terminal; and
a second power supply comprising a second power output terminal which outputs a second power supply voltage, a second abnormal output terminal configured to provide a second abnormal signal based on the occurrence of an abnormality, and a second reset input terminal,
wherein the first power supply is configured to stop providing the first power supply voltage and provide the first abnormal signal based on the first reset input terminal receiving the second abnormal signal, and
wherein the second power supply is configured to stop providing the second power supply voltage and provide the second abnormal signal based on the second reset input terminal receiving the first abnormal signal.

2. The power circuit according to claim 1, wherein the first power supply further comprises a first enable input terminal configured to receive a first enable signal,
wherein the second power supply further comprises a second enable input terminal configured to receive a second enable signal,
wherein the first power supply is further configured to stop providing the first abnormal signal based on the reception of the first enable signal being stopped, and
wherein the second power supply is further configured to stop providing the second abnormal signal based on the reception of the second enable signal being stopped.

3. The power circuit according to claim 2, wherein the first power supply further comprises:
a first transistor comprising a first electrode connected to the first abnormal output terminal and a second electrode configured to receive a first voltage; and
a first abnormality detector configured to turn on the first transistor based on the occurrence of an abnormality in the first power supply, and
wherein the first abnormality detector is configured to operate while receiving the first enable signal.

4. The power circuit according to claim 3, wherein the second power supply further comprises:
a second transistor comprising a first electrode connected to the second abnormal output terminal and a second electrode configured to receive the first voltage; and
a second abnormality detector configured to turn on the second transistor based on the occurrence of an abnormality in the second power supply, and
wherein the second abnormality detector is configured to operate while receiving the second enable signal.

5. The power circuit according to claim 4, wherein the first abnormal output terminal and the second reset input terminal are connected to a first electrode of a first pull-up resistor, and
wherein a second electrode of the first pull-up resistor is configured to receive a second voltage.

6. The power circuit according to claim 5, wherein the second abnormal output terminal and the first reset input terminal are connected to a first electrode of a second pull-up resistor, and
wherein a second electrode of the second pull-up resistor is configured to receive the second voltage.

7. The power circuit according to claim 6, wherein the first power supply further comprises:
a first power supply voltage generator configured to generate the first power supply voltage; and
a first on-off controller configured to control the first abnormality detector to turn on the first transistor and to stop operation of the first power supply voltage generator based on receiving the second abnormal signal, and
wherein the first power supply voltage generator and the first on-off controller are configured to operate while receiving the first enable signal.

8. The power circuit according to claim 7, wherein the second power supply further comprises:
a second power supply voltage generator configured to generate the second power supply voltage; and
a second on-off controller which is configured to control the second abnormality detector to turn on the second transistor and to stop operation of the second power supply voltage generator based on receiving the first abnormal signal, and
wherein the second power supply voltage generator and the second on-off controller are configured to operate while receiving the second enable signal.

9. The power circuit according to claim 8, wherein the first power supply further comprises a first buffer between the first reset input terminal and the first on-off controller.

10. The power circuit according to claim 9, wherein the second power supply further comprises a second buffer between the second reset input terminal and the second on-off controller.

11. A display device comprising:
a first power supply comprising a first power output terminal configured to provide a first power supply voltage, a first abnormal output terminal configured to provide a first abnormal signal based on the occurrence of an abnormality, and a first reset input terminal;
a second power supply comprising a second power output terminal configured to provide a second power supply voltage, a second abnormal output terminal configured to provide a second abnormal signal when an abnormality occurs, and a second reset input terminal; and
a display panel connected to the first power output terminal and the second power output terminal,
wherein the first power supply is configured to stop providing the first power supply voltage and provide the first abnormal signal based on the first reset input terminal receiving the second abnormal signal, and
wherein the second power supply is configured to stop providing the second power supply voltage and provides the second abnormal signal based on the second reset input terminal receiving the first abnormal signal.

12. The display device according to claim 11, wherein the first power supply further comprises a first enable input terminal configured to receive a first enable signal,
wherein the second power supply further comprises a second enable input terminal configured to receive a second enable signal,
wherein the first power supply is configured to stop providing the first abnormal signal based on the reception of the first enable signal being stopped, and
wherein the second power supply is configured to stop providing the second abnormal signal based on the reception of the second enable signal being stopped.

13. The display device according to claim 12, wherein the first power supply further comprises:
a first transistor comprising a first electrode connected to the first abnormal output terminal and a second electrode configured to receive a first voltage; and
a first abnormality detector configured to turn on the first transistor based on the occurrence of an abnormality in the first power supply, and
wherein the first abnormality detector is configured to operate while receiving the first enable signal.

14. The display device according to claim 13, wherein the second power supply further comprises:
a second transistor comprising a first electrode connected to the second abnormal output terminal and a second electrode configured to receive the first voltage; and
a second abnormality detector configured to turn on the second transistor based on the occurrence of an abnormality in the second power supply, and
wherein the second abnormality detector is configured to operate while receiving the second enable signal.

15. The display device according to claim 14, wherein the first abnormal output terminal and the second reset input terminal are connected to a first electrode of a first pull-up resistor, and
wherein a second electrode of the first pull-up resistor is configured to receive a second voltage.

16. The display device according to claim 15, wherein the second abnormal output terminal and the first reset input terminal are connected to a first electrode of a second pull-up resistor, and
wherein a second electrode of the second pull-up resistor is configured to receive the second voltage.

17. The display device according to claim 16, wherein the first power supply further comprises:
a first power supply voltage generator configured to generate the first power supply voltage; and
a first on-off controller configured to control the first abnormality detector to turn on the first transistor and to stop operation of the first power supply voltage generator based on receiving the second abnormal signal, and
wherein the first power supply voltage generator and the first on-off controller are configured to operate while receiving the first enable signal.

18. The display device according to claim 17, wherein the second power supply further comprises:
a second power supply voltage generator configured to generate the second power supply voltage; and
a second on-off controller which is configured to control the second abnormality detector to turn on the second transistor and to stop operation of the second power supply voltage generator based on receiving the first abnormal signal, and
wherein the second power supply voltage generator and the second on-off controller are configured to operate while receiving the second enable signal.

19. The display device according to claim 18,
wherein the first power supply further comprises a first buffer between the first reset input terminal and the first on-off controller, and
wherein the second power supply further comprises a second buffer between the second reset input terminal and the second on-off controller.

20. An electronic device comprising:
a display device configured to display an image; and
a power circuit configured to provide power to the display device, and comprising:
a first power supply comprising a first power output terminal configured to provide a first power supply voltage, a first abnormal output terminal configured to provide a first abnormal signal based on the occurrence of an abnormality, and a first reset input terminal; and
a second power supply comprising a second power output terminal which outputs a second power supply voltage, a second abnormal output terminal configured to provide a second abnormal signal based on the occurrence of an abnormality, and a second reset input terminal,
wherein the first power supply is configured to stop providing the first power supply voltage and provide the first abnormal signal based on the first reset input terminal receiving the second abnormal signal, and
wherein the second power supply is configured to stop providing the second power supply voltage and provide the second abnormal signal based on the second reset input terminal receiving the first abnormal signal.
